(19) United States
(12) Patent Application Publication
(10) Pub. No.: US 2023/0211369 A1
(43) Pub. Date: Jul. 6, 2023

(54) Arid Land Sprinkler

(71) Applicant: United Arab Emirates University, Al-Ain (AE)

(72) Inventors: Chandana Chakraborty, Al Ain (AE); Ali H. Al-Marzouqi, Al-Ain (AE)

(21) Appl. No.: 17/567,419

(22) Filed: Jan. 3, 2022

(51) Int. Cl. B05B 3/12; B05B 3/04

(52) U.S. Cl. CPC B05B 3/12; B05B 3/0418

(57) ABSTRACT

An arid land sprinkler device includes a sprinkler head frame having a base connectable to a water supply source; at least one sprinkler arm extending from the sprinkler head frame, the sprinkler arm receiving water from the water supply source, wherein water source pushes a piston rod positioned within a pop-up box which consequentially pushes a shaft tube of the arid land sprinkler device also positioned within the pop-up box, causing the shaft tube to pop upwards and open outside of the pop-up box, causing a hydraulic arm with an aerator screen to open. A process of showering raindrops for watering an area using an arid land sprinkler is also disclosed enabling the at least one sprinkler arm to rotate in a full circle (360°) or a half circle (180°), based on plant needs, thereby preventing evaporation, overwatering of root zones, and overlapping wetting zones.

### FIELD OF THE INVENTION

The present invention relates to the field of irrigation systems such as rotary and pop-up water sprinklers, and more particularly to a lawn or garden sprinkler having a tripod structure for irrigation purposes.

### BACKGROUND OF THE INVENTION

Background description includes information that will be useful in understanding the present invention. It is not an admission that any of the information provided herein is prior art or relevant to the presently claimed invention, or that any publication specifically or implicitly referenced is prior art.

The present arid land sprinkler is especially adapted for use in arid land. In US20110198420A1 the bubbler sprinkler head eliminates the destructive energy from sprayed irrigating water by mixing the water with air bubbles prior to the water hitting the ground in a drop line of a central irrigation system. Generally, wheeled line irrigation systems include a plurality of wheeled towers supporting a linear water conduit in a manner that the wheeled towers and water conduit can be moved through an agricultural field for changing the position of irrigation bubblers coupled to the water conduit. Run-off occurs when water is applied too fast, or in too great an amount.

In U.S. Pat. No. 4,303,203 patent, a center pivot irrigation system includes an irrigation line supported by towers and rotatable about a central pivot. One tower thereof, for example the outermost tower, includes a drive motor energized in response to a signal from a pressure responsive control apparatus. The control apparatus is operable to sense the magnitude of the water pressure at a selected location in the line and therefore to sense decreases in such water pressure when the line travels uphill and increases in the pressure when the line travels downhill. In U.S. Pat. No. 5,307,993 patent, rotary sprinklers has plurality of jet driven arms for distributing water on a lawn or garden. U.S. Pat. No. 4,905,903 (entitled ‘Sprinkler’) discloses a contemporary rotary sprinkler having three arms, or ‘nozzle supports’, with each such arm having a rotatable nozzle head disposed on the distal end thereof. Each nozzle head is selectively rotatable between three independent positions, with a different number of nozzles placed in use in each position. The angular orientation of each nozzle head may also be independently adjusted, thereby controlling the rotational velocity of the arm assembly. The industry traditionally also has a rotary sprinkler of simplified design and operation, which provides a suitable variety of water distribution patterns and rotational velocities.

Further, a LEPA irrigation system (Low Energy Precision Application) is used in systems as seen in US20110198420A1 to reduce destructive forces of water, and to prevent damage and erosion to the furrow and adjacent crops. LEPA irrigation products generally bounce the water spray off different surfaces until the water is directed towards the ground. The water spray directed towards the ground in this manner has less energy but it still contains enough energy to erode furrows, wash out seeds and compact the soil. In U.S. Pat. No. 5,439,176A—a lawn-garden sprinkler having a tripod structure explains the elevated sprinkler head position and its advantages in that the length of the water spray and the overall width of the water spray are somewhat increased. This increase is due to a greater vertical distance for the water droplets to travel during the motion of the droplets away from the sprinkler head. The sprinkler head is mounted on an essentially vertical water supply pipe that is affixed to the upper end of a supporting tripod.

A pop-up sprinkler is disclosed in U.S. Pat. No. 2,812,977A, comprising a casing with a top portion adapted to be installed substantially with the lawn ground level. The casing has a bore and a water supply pipe connection at the lower end of bore, a tubular spray nozzle is mounted in the bore, the nozzle having a tubular spray head on the upper portion, at the level of the casing top portion in the retracted position of the nozzle, and a piston there below, responsive to the arrival of water under pressure to lift the spray head out of the casing. U.S. Pat. No. 3,315,897 discloses using insect guards for sprinklers. The insect guard for irrigation nozzles leads to blocking access to a nozzle. In overhead irrigation systems of the mechanical sprinkler type the ingress of insects to the orifice of the nozzle has presented problems. It has been discovered in the States of Florida and Hawaii, among other places, that mud daubers, hornets, and other insects are attracted to nozzle orifices. They pack foreign material into the nozzles so solidly and adhesively, eventually leading to removal only by boring or reaming the nozzle. This occurs during quiescent or off periods of the system when the equipment is standing idle. However, when a next system is activated, the blocked nozzle remains inoperable and the effectiveness of the system is reduced.

Accordingly, there exists a need for a sprinkler device or system, which overcomes the drawbacks faced by traditionally employed land sprinklers.

### SUMMARY OF THE INVENTION

Therefore it is an object of the present invention to develop a sprinkler device or system, which overcomes the drawbacks faced by traditionally employed land sprinklers.

There is disclosed an arid land sprinkler device, comprising a sprinkler head frame having a base connectable to a water supply source, at least one sprinkler arm extending from the sprinkler head frame, wherein the at least one sprinkler arm receives water from the water supply source, wherein water pushes a piston rod positioned within a pop-up box which consequentially pushes a shaft tube of the arid land sprinkler device also positioned within the pop-up box, causing the shaft tube to pop upwards and open outside of the pop-up box.

In an embodiment of the present invention, a turbine and gear arrangement are present in connection with the sprinkler head frame. This rotates the hydraulic arm having the aerator screens, which are small mesh screens that break up the flow of water into multiple small streams, adding air in between. By diluting the water stream with air, aerators significantly reduce the volume of water flowing from the faucet. They do this while maintaining the feeling of a high-pressure flow for showering water as raindrops in a downward directed shower of water.

In another embodiment of the present invention, the shaft tube is a collapsible shaft tube divided into a plurality of sections such as a first inner tube is lined by a pressure sheath, a second inner tube lined by the pressure sheath and an innermost connector tube also lined by pressure sheath to make it durable.

In another embodiment of the present invention, the shaft tube further comprises a bowl-shaped collection chamber lined by protective pressure sheath for distributing pressurized water to the hydraulic arm system and to the turbine and gear arrangement.

In another embodiment of the present invention, at least one hydraulic sprinkler arm receives water which pushes the small plunger which in turn pushes the big plunger to make the arm functional, when the shaft tube opens outside the pop-up box.

In another embodiment of the present invention, the aerator screen comprises a plurality of water outlet ports. Aerator screens are small mesh screens that break up the flow of water into multiple small streams, adding air in between.

In another embodiment of the present invention, pressure and flow of the water being showered from the at least one sprinkler arm is controlled by altering hole size of the plurality of water outlet ports located on the aerator screen.

In another embodiment of the present invention, a relationship between pressure (P), flow (Q), and K-factor (K) is Q=K√P.

In another embodiment of the present invention, the at least one sprinkler arm is positioned within the pop-up box when not in operation, thereby preventing external damage.

In another embodiment of the present invention, each of the at least one sprinkler arm comprises a first plunger, in connection with a second plunger, which helps to magnify the force of water (like the concept of an injection syringe), then at least one sprinkler arm opens for operation, on receipt of water from the water supply source.

In another embodiment of the present invention, the turbine and gear arrangement enable the at least one sprinkler arm to rotate in a full circle movement (360°) or a half circle movement (180°), based on a particular requirement.

As another aspect of the present invention, a process for watering an area using an arid land sprinkler, the process comprising: allowing water from a water source supply to reach a sprinkler head frame; pushing a piston rod in connection with a collapsible shaft tube to open and emerge from inside a pop-up box, the pop-up box positioned at a base of the sprinkler head frame; allowing water to flow to a connector tube, the connector tube being a part of the collapsible shaft tube leading to the collection chamber; distributing pressurized water from the collection chamber to a turbine and gear arrangement positioned at a top portion of the sprinkler head frame; and also to the hydraulic arms to open, enabling rotation of a plurality of hydraulic sprinkler arms in connection with the sprinkler head frame, showering the water over the area to be watered.

In an embodiment of the present invention, water is showered as raindrops in a downward directed shower via an aerator screen of the hydraulic arm attached to the collection chamber, which is rotated by the turbine and gear arrangement, the aerator screen comprising plurality of water outlet ports. Aerator screens are small mesh screens that break up the flow of water into multiple small streams, adding air in between.

In another embodiment of the present invention, controlling the pressure and flow of the water being showered from the plurality of sprinkler arms is done by altering hole size of the plurality of water outlet ports located on the aerator screen.

In another embodiment of the present invention, the process further comprises enabling the plurality of sprinkler arms to rotate in a full circle movement(360°) or a half circle movement(180°) using the turbine and gear arrangement, based on a particular requirement, thereby preventing overwatering root zones, and overlapping wetting zones.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a perspective view of the various parts of an arid land sprinkler, in accordance with the present invention.

FIG. 2 is a sectional view of the pop-up-box, in accordance with the present invention.

FIG. 3A is a sectional view of a collapsible shaft.

FIG. 3B is a sectional view of the collection chamber in accordance with the present invention.

FIG. 4 is a perspective view of the various parts of hydraulic sprinkler arm, in accordance with the present invention.

FIG. 5 is a sectional view of the hydraulic sprinkler arms of the arid land sprinkler, in accordance with the present invention.

FIG. 6 is a sectional view of the turbine and gear arrangement, in accordance with the present invention.

FIG. 7A shows various applications of the arid land sprinkler.

FIG. 7B shows single arm sprinkler for small and uneven areas in accordance with the present invention.

FIG. 8 illustrates wetting depth, wetting area pattern and arrangement of the commonly used land sprinkler, in comparison with the present invention.

### DETAILED DESCRIPTION OF THE INVENTION

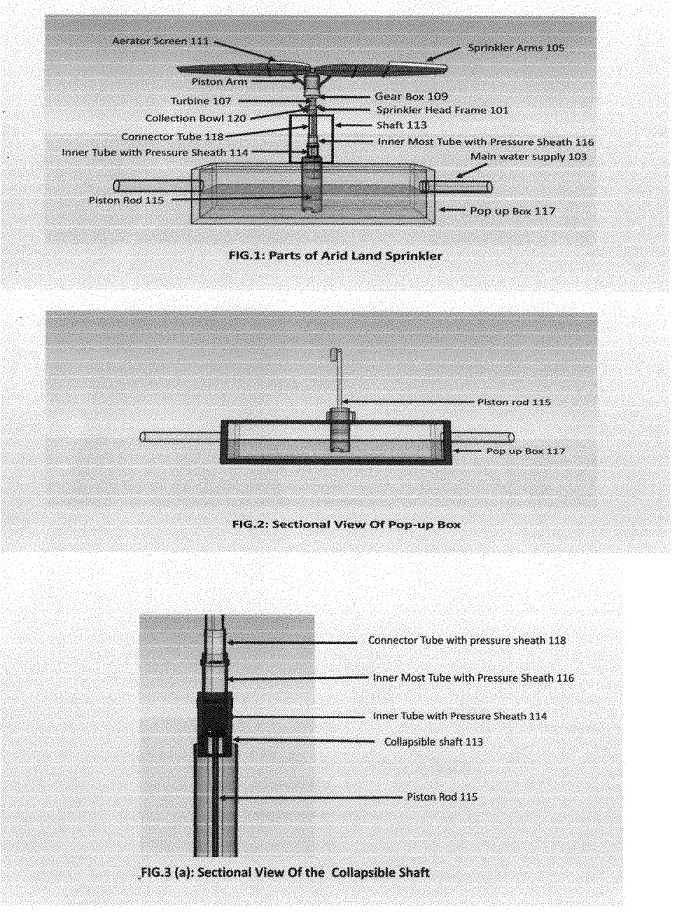

The aspects of the proposed arid land sprinkler, according to the present invention will be described in conjunction with FIGS. 1-8. In the Detailed Description, reference is made to the accompanying figures, which form a part hereof, and in which is shown by way of illustration specific embodiments in which the invention may be practiced. It is to be understood that other embodiments may be utilized and logical changes may be made without departing from the scope of the present invention. The following detailed description, therefore, is not to be taken in a limiting sense, and the scope of the present invention is defined by the appended claims.

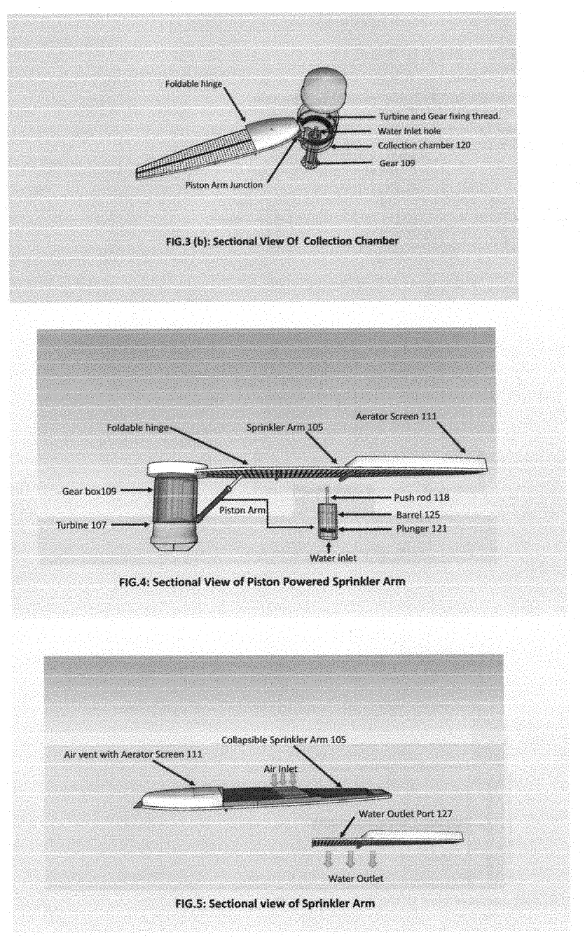

The present invention discloses an arid land sprinkler for use in an irrigation system. As depicted in FIG. 1, the proposed arid land sprinkler for an irrigation sprinkler system has a sprinkler head frame 101 with a base 100 connectable to the main water supply 103 and has a plurality of sprinkler arms 105 extending therefrom. The said arms 105 are attached to the sprinkler head frame 101 for receiving water and subsequently showering water in the form of raindrops there through—unlike that of watering from a point source. A turbine 107 and gear arrangement 109, is further attached to the sprinkler head frame 101. The sprinkler arm 105, with aerator screen 111, made of small mesh screens break up the flow of water into multiple small streams, adding air in between. By diluting the water stream with air, aerators significantly reduce the volume of water flowing from the faucet. They do this while maintaining the feeling of a high-pressure flow, showering water—for an exact mimicry of rainfall Water from the supply line 103 pushes a piston rod 115 (positioned within a pop-up box 117), which in turn pushes a collapsible shaft tube 113 of the sprinkler to pop up. As an after effect of this, various parts of the collapsible shaft tube 113 open. As shown in FIG. 3A, the collapsible shaft tube is divided into connector tube further comprising a first inner tube 114 with a pressure sheath, a second inner tube 116 with a pressure sheath and an innermost connector tube 118 also with a pressure sheath. The collapsible shaft tube 113 then pushes water to collection chamber 120, then water reaches the hydraulic sprinkler arms 105 with force. As depicted in FIG. 4, within each of the hydraulic sprinkler arms 105, there is located a first plunger (smaller) 119, which pushes a second plunger (larger) 121, as an effect of which the hydraulic sprinkler arms 105 open and move upwards. Subsequently, water from the main water supply 103 flows through the shaft tube 113, then through the collection chamber 120 and reaches the turbine 107 and gear arrangement 109, thereby rotating the hydraulic sprinkler arms 105. The gear arrangement 109 assists the hydraulic sprinkler arms 105 to move in a 360° axis (full circle movement) or a 180° axis (half circle movement), as per the specific requirement. The hydraulic sprinkler arms 105 have a tubular housing holding an aerator screen 111 that comprises a plurality of water ports, which shower water on the plants or crops as raindrops.

The present land sprinkler as depicted in FIG. 1, has many applications in areas such as orchards, gardens, crop fields, farms, and lawns. Several benefits associated with the land sprinkler of the present invention include no wastage of water and energy, easy installation steps (folding rod of the shaft saves space), and cheap to manufacture, considering that a wide variety of materials may be used. Further, the proposed land sprinkler overcomes many drawbacks of traditionally implemented sprinklers, such as the ability to control water pressure and enabling showering of water in full or half circles as raindrops. Accordingly, a uniform wetting zone is achieved along with adjustable operations. For example, when leaching of excessive salts is required, forceful and large raindrops are showered, and a slower operation performed for efficient water infiltration when irrigation of plants is needed. This reduces overall water and energy needs, assists in efficiently irrigating crops. Where plants or crop population per unit area is high, it also saves water as uniform raindrops are showered and not sprayed from a single point source. Accordingly, the present invention is suitable for all soil types and does not excessively wet leaves (and influences greater conductive microclimate). Another advantage is the possibility of using soluble fertilizers, as there are less problems induced by defects such as clogging (as seen in traditionally used sprinklers).

The proposed arid land sprinkler as depicted in FIG. 1 saves water and energy, and thickness of the hydraulic sprinkler arms 105 may be altered to increase or decrease the amount of the water shower as per the requirement. Height of the shaft tube 113 may also be altered to suit the needs of different plant species. Further, with the proposed arid land sprinkler, there are no overlapping wetting areas. The water pressure and the size of the water drops can be altered according to the seasonal requirements just like rainfall to stop the leaching of soil nutrients and run offs. The area watered will maintain soil moisture, by mimicking the real effects of rainfall, which will have a uniform deep wetting zone that is completely different from the V shaped wetting zone of existing conventional sprinklers.

The gear arrangement 109 as depicted in FIG. 6, enables water to be sprayed in adjustable arcs, to suit needs of specific plant varieties. Further, amount of water evaporation due to wind drift is less, as the water is not sprayed upwards. In an embodiment of the present invention, the proposed sprinkler heads are ‘matched-rainfall’ sprinkler heads, meaning they guarantee that a half-circle head will deliver just as much water per square foot as a full-circle head showering the same area. Therefore, matched simply means that all sprinkler heads deliver a uniform amount of water across each square foot of an irrigated area. The small radius of an altered small sprinkler arm makes the arid land sprinkler suitable to be installed for smaller and unevenly shaped areas as depicted in FIG. 7B. There is no wastage and spillage of water when the sprinkler is installed near boundary walls, in the lawn corners near pavements, installed to water big trees, or in uneven farms and gardens. The water comes out like raindrops directed downwards and there is no spillage and runoffs. In uneven gardens, farms, crop fields, better infiltration will reduce washing away of valuable topsoil.

The hydraulic sprinkler arms 105 move inside the pop-up box 117, when not in use, and thereby the hydraulic sprinkler arms 105 are not prone to damages or attacks (especially when installed in public places like parks or gardens). Also, considering that the water being showered is not forced in an upwards direction—a high operating pressure is not required. Further, as the water shower is directed in a uniform and downward direction, the showered water does not lead to salts being concentrated near the plants' root zones (prevents salt build-up and facilitates deep watering which encourages deep rooting). The proposed sprinkler requires low maintenance operations and is relatively trouble free. The water being showered through the proposed land sprinkler does not wet the leaves of the plant as excessively as a continuous spray of water from a point source would. In addition, overall operation is simple, the sprinkler is easy to monitor, and water is delivered evenly where needed. This in turn improves growth of foliage and retains a fresh appearance of the plants.

As another aspect of the present invention, an irrigation system is proposed for arid land (watering lawns, gardens, and crop fields for irrigation purposes). During operation, the long and collapsible shaft tube 113 moves upwards and water is showered onto the plants or soil, like rainfall. Size of the water drops may be altered (increased or decreased) as per the need of the specific plant or crop species to be watered. Uniform wetting of the soil is achieved using the proposed sprinkler with no overlapping zones. Water pressure may also be altered to leach out salt with less water seaping away from the rooting zone as the water drops are directed downwards and a duration of the water showering spell may also be pre-scheduled. Wind and/or sun caused evaporation is less compared to traditional sprinkler nozzles which throw water upwards or sidewards, thereby saving water and energy. The long collapsible shaft 113 in accordance with the present invention has an adjustable height and moves upwards from the pop-up box 117 when required, pushing the plurality of hydraulic sprinkler arms 105 to open up, and commence functioning of the turbine 107 to rotate the arms to produce spells of rain showers—and subsequently moves back inside the pop-up box 117 (underground) when not in use. The collapsible shaft tube 113 is housed within grooves to enable folding in of at least two hydraulic sprinkler arms 105, thereby protecting the plurality of small holes of the hydraulic sprinkler arms 105 from dust, mud and/or insects. In another embodiment, the collapsible shaft tube 113 may also be fixed or planted permanently at a desired location (for example, in big fields permanently like streetlight poles fixed at certain required distances),In another embodiment, the irrigation arid land sprinkler in accordance with the present invention (as illustrated in FIGS. 1-3), has a sprinkler head frame 101 with a connection for attaching itself to a main water supply 103 or a hose. The sprinkler head frame 101 further includes a pop-up-box 117 in direct connection with a water passageway going therethrough via a collapsible shaft 113 made of a plurality of sliding inside each other tube portions—namely a first inner tube 114 with a pressure sheath, a second inner tube 116 with a pressure sheath and an innermost connector tube 118 also with a pressure sheath. The innermost connector tube 118 leads to the collection chamber 120 which pushes water towards a plurality of hydraulic sprinkler arms 105 extending therefrom. Each of the hydraulic sprinkler arms 105 includes a tubular housing with an aerator screen 111 and a plurality of water ports, for showering or directing water therefrom (as raindrops). Aerator screens are small mesh screens that break up the flow of water into multiple small streams, adding air in between. By diluting the water stream with air, aerators significantly reduce the volume of water flowing from the faucet.

A turbine 107 and gear arrangement 109 is further attached to the sprinkler head frame 101—which is also in connection with the collection chamber 120 connected to the innermost connector tube 118. The said turbine 107 and gear arrangement 109 enables turning or rotating of the plurality of hydraulic sprinkler arms 105 for achieving an even wetting zone.

In another embodiment, the collapsible shaft tube 113 is formed of a first inner tube 114 with a pressure sheath, a second inner tube 116 with a pressure sheath and an innermost connector tube 118 also with a pressure sheath. The pressure sheath extends from a base 100 to a tip of the collapsible shaft tube 113, and makes the shaft tube 113 durable during the collapse operations. Owing to a pressure of the water supply through the main water supply 103 when shut off, the weight of the sprinkler causes it to drop under the force of gravity into its retracted position within the pop-up-box 117 which houses the sprinkler head frame 101 when not in use. In contrast, when the water supply 103 is turned on—the piston rod 115 pushes the sprinkler head frame 101 out of the pop-up box 117. The shaft tube 113 is collapsible under the force of external pressure which is greater than the formed internal pressure when the water is turned off. In another embodiment of the present invention, an upper portion of the collapsible shaft tube 118 leads to the bowl shaped collection chamber 120, having walls lined by pressure sheaths for durability as depicted in FIG. 3B—for distributing pressurized water to the turbine 107 and gears 109, and subsequently to the hydraulic sprinkler arms 105. Water reaching the collection chamber 120, is distributed to the hydraulic arm opening and to the turbine and gear system. This causes the rotational movement and the shower of water.

In an embodiment of the present invention, the hydraulic arms 105 are attached to the collection chamber 120. Pascal invented the syringe and created the hydraulic press—an instrument based upon the principle that became known as Pascal's principle, wherein pressure applied to a confined liquid is transmitted undiminished through the liquid in all directions regardless of the area to which the pressure is applied.

An operation of the proposed arid land sprinkler is seen using FIGS. 6-8, wherein water from the supply line 103 pushes the collapsible shaft tube 113 of the sprinkler to pop up, and the water forces itself through the collapsible shaft tube 113, runs through the collection chamber 120, passes through the opening in the shaft 131—causing the turbine component 107 to turn. This turning of the turbine 107 causes a series of gears 109 to rotate, thereby leading to rotation of the sprinkler head. In other words, a rotor system is activated by water entering the sprinkler from the water source 103.

FIG. 7A and FIG. 7B show various applications of the arid land sprinkler, in accordance with the present invention—which can be installed for greater benefits in crop fields, tree orchards, farms, gardens and lawns.

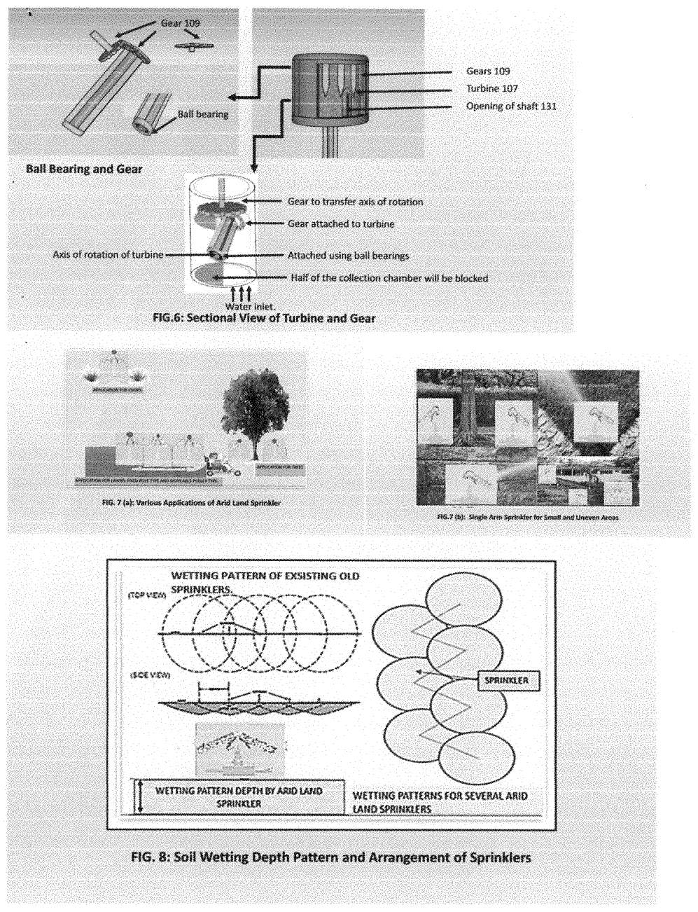

Based on the above explanations, it is clear that the proposed irrigation arid land sprinkler in accordance with the present invention is effective in producing showers of rainfall, which is fed with water through the connecter tube 118, which has output via a plurality of water outlet ports, and falls gently on the ground. FIG. 8 specifically illustrates a wetting depth pattern and arrangement of the proposed land sprinkler, in contrast to conventional sprinkler heads which discharge water in the form of a trajectory, where the sprayed water initially rises against gravity and then falls.

Complications faced by traditional land sprinklers are eradicated by the arid land sprinkler proposed in the present invention, wherein like bubblers, its not a spray of water—watering happens as showers of rainfall. In the traditional bubbler based sprinkler, water is forcefully sprayed from a point source, wets plant leaves and areas that need to be avoided, whereas in arid land sprinkler water falls like rainfall The proposed arid land sprinkler type is exactly like rainfall to make the land fertile, overwatering and wastage of water is not possible with this sprinkler type. As it can rise from below the ground, the elaborate irrigation system of wheeled line is not required. The proposed arid land sprinkler does not need any complicated arrangements as it can be planted or installed anywhere and is cheap to maintain. Pressure differences are also efficiently managed as the sprinkler owing to these features, does not require high water pressure for its functioning.

The arid land sprinkler arm rotates and generally has two arms to counterbalance the rainfall shower. It is not water spayed out from a point source, but like raindrops distributed evenly over a large area. The proposed structure is not expensive, and can be adjusted for a variety of water distribution patterns (depending on the hole size of the water ports of the hydraulic arms) and number of arms attached. Complicated rotational velocities are also not needed as in traditional sprinklers, as the only aim of the arid land sprinkler is to cover the area like rainfall. The arid land sprinkler mimics rainfall by providing uniform drop size and spray duration. This helps in plant growth, increases soil fertility, stops soil erosion, washing away of seeds, and also stop leakage of nutrients from soil (thereby being unavailable to plants and collection of run off in water bodies as pollutants).

The height elevation used in the proposed arid land sprinkler allows the shower of raindrops to reach the soil with uniform force and controls evaporation, in hot and arid areas. Further, in accordance with the present invention, the sprinkler is capable of being installed as per plant needs (there is no labor-intensive process of fixing a stand and removal of the same after every use). Further, in the arid land sprinkler, pushing of the piston and a pop-up mechanism is used, however with a benefit of the collapsible shaft emerging out and pushing the hydraulic arms to open. As the arms open, water is showered like rainfall and not sprayed from a point source. The said hydraulic arms are made of collapsible joints such that they are folded when not in use—thereby proving to be an advanced irrigation system in comparison with the traditional systems. Also, with the proposed land sprinkler, use of insect guards is not needed, as the arms 105 of the sprinkler head 101 are folded along the collapsible shaft 113. The proposed arid land sprinkler retreats in the pop up box 117 when not in use. The range of available or traditional sprinkler heads discharge water that makes a trajectory, where the water first rises against gravity and then falls. In contrast, the proposed land sprinkler saves both energy and water, as the discharge of water is towards gravity just like rainfall A traditional sprinkler system when in use has low efficiency as it irrigates from a point source—so twice the amount of water is needed to obtain an even coverage. Some spray irrigation systems emits water faster than soil can absorb and hence cause runoffs. The continuous water from traditional sprinklers wets the leaves/foliage and encourage more evaporation due to wind drift. In the proposed sprinkler device, aerator plates with holes of varying diameters and altered shaft heights can be selected for different crops and in different seasons—depending on the evaporation/transpiration rate in the particular area.

The proposed hydraulic arms open due to water pressure applied on the small plunger 119 and eventually on the big plunger 121. The shower eliminates the problem of overwatering root zones and overlapping wetting zones, thereby saving water and avoiding soil salinization in arid lands. In another embodiment, the arid land sprinkler for an irrigation sprinkler system in accordance with the present invention has feasibility for frequent and small water dosage applications to suit the special needs of germination, cooling and frost protection based on a dose requirement. Pressure and flow of the water being showered is controlled by altering hole size of the plurality of water outlet ports located on the aerator screen. Aerator screens are small mesh screens that break up the flow of water into multiple small streams, adding air in between. By diluting the water stream with air, aerators significantly reduce the volume of water flowing from the faucet. They do this while maintaining the feeling of a high-pressure flow.

A vast selection of emitters and water outlet port facilitates, matching the water application rate to the intake rate of the soil can be used. Uniform distribution of water in the field renders high water use efficiency. The sprinklers are spaced out in a zigzag manner so that an entire area is watered evenly, without having overlapping areas, overwatered zones or water wastage.

Many changes, modifications, variations and other uses and applications of the subject invention will become apparent to those skilled in the art after considering this specification and the accompanying drawings, which disclose the preferred embodiments thereof. All such changes, modifications, variations and other uses and applications, which do not depart from the spirit and scope of the invention, are deemed to be covered by the invention, which is to be limited only by the claims which follow.

1. An arid land sprinkler device, comprising:
a sprinkler head frame having a base connectable to a water supply source;
at least one sprinkler arm extending from the sprinkler head frame, wherein the at least one sprinkler arm is configured to receive water from the water supply source, wherein water from the water supply source is positioned to push a piston rod positioned within a pop-up box which is configured to consequentially push a shaft tube of the arid land sprinkler device also positioned within the pop-up box, causing the shaft tube to pop upwards and open outside of the pop-up box.

2. The arid land sprinkler device of claim 1, further comprising:
a turbine and gear arrangement in connection with the sprinkler head frame and configured to rotate the at least one sprinkler arm of the arid land sprinkler device for showering water.

3. The arid land sprinkler device of claim 1, wherein the shaft tube is a collapsible shaft tube divided into a plurality of sections comprising a first tube, a second inner tube, and an innermost connector tube; wherein the first tube, the second inner tube and the innermost connector tube are lined with a pressure sheath for durability and the first tube and the second inner tube slide inside each other when not in use.

4. The arid land sprinkler device of claim 3, wherein the shaft tube leads to a bowl-shaped collection chamber also lined with a pressure sheath for distributing pressurized water to a turbine and gear arrangement and to the at least one sprinkler arm. Half of the water inlet of this chamber is blocked to reduce the speed of the turbine which in turn rotates the sprinkler arm. When water strikes the turbine blades, it causes the turbine to rotate unidirectional. The turbine is connected to a gear which transform the horizontal axis of rotation to vertical axis of rotation. This module provides torque to the sprinkler frame to rotate. The gear is attached firmly to the sprinkler rotation frame with ball bearings making it to rotate smoothly.

5. The arid land sprinkler device of claim 4, wherein the shaft tube is of an adjustable height and is configured to move upwards out of the pop-up box when required, pushing at least one sprinkler arm to open up and commence functioning of the arid land sprinkler device, the at least one sprinkler arm opens by water pressure as the at least one sprinkler arm receives water from the bowl-shaped collection chamber to open outside of the pop-up box.

6. The arid land sprinkler device of claim 2, wherein the at least one sprinkler arm comprises a plurality of water outlet ports and an aerator screen, which is a mesh screen that breaks up flow of water into multiple streams and mixes air. The sprinkler arms have mesh screen with pores and air vents which are fine slits to allow air to mix up with water and make the water droplets tiny and bubbled. The sprinkler arm is made in a telescopic collapsible way so that it can go inside the pop-up box.

7. The arid land sprinkler device of claim 6, wherein the pressure and the flow of the water being showered from the at least one sprinkler arm is controlled by altering the hole size of the plurality of water outlet ports.

8. The arid land sprinkler device of claim 7, wherein a relationship between pressure (P), flow-rate (Q), and K-factor (K) is Q=K√P. To explain in detail this equation can also be used. q=n×a×cd\sqrt{2×g×h} explains amount of water sprinkled (flow) where q=flow (water port discharge) (m²/sec), n=number of sprinklers installed, a=cross section area of nozzle (m²), h=pressure head of the nozzle, cd=coefficient of discharge, g=acceleration due to gravity (m/sec).

9. The arid land sprinkler device of claim 1, wherein the at least one sprinkler arm is positioned within the pop-up box when not in operation, thereby preventing external damage.

10. The arid land sprinkler device of claim 1, wherein each sprinkler arm of the at least one sprinkler arm comprises a plunger, in connection with a barrel, which is a simple piston that helps to force each sprinkler arm to open for operation, on receipt of water pressure from the water supply source.

11. The arid land sprinkler device of claim 2, wherein the turbine and gear arrangement enable the at least one sprinkler arm to rotate in a full circle movement (360°) or a half circle movement (180°), based on a desired movement, thereby preventing overwatering of root zones, and overlapping wetting zones.

12. A process for watering an area using an arid land sprinkler, the process comprising:
allowing water from a water source supply to reach a sprinkler head frame;
pushing a piston rod in connection with a collapsible shaft tube to open and emerge from inside a pop-up box, the pop-up box positioned at a base of the sprinkler head frame; allowing water to flow to a connector tube leading to a collection chamber, to distribute pressurized water to a plurality of hydraulic arms and to a turbine and gear arrangement positioned at a top portion of the sprinkler head frame; thereby enabling rotation of the plurality of hydraulic arms in connection with the sprinkler head frame, along with showering water over the area to be watered.

13. The process of claim 12, wherein water is showered as raindrops in a downward directed shower of water via an aerator screen attached to the turbine and gear arrangement, the aerator screen comprising plurality of water outlet ports.

14. The process of claim 13, wherein controlling a pressure and flow of the water being showered from the plurality of sprinkler arms is done by altering hole size of the plurality of water outlet ports located on the aerator screen.

15. The process of claim 13, wherein a relationship between pressure (P), flow (Q), and K-factor (K) is Q=K√P.

16. The process of claim 12, further comprising positioning the plurality of sprinkler arms within the pop-up box when not in operation, thereby preventing external damage.

17. The process of claim 12, further comprising enabling the plurality of sprinkler arms to rotate in a full circle movement (360°) or a half circle movement (180°) using the turbine and gear arrangement, based on a particular requirement, thereby preventing overwatering root zones and overlapping wetting zones.

18. An arid land sprinkler device, comprising:
a pop-up box connected to a water supply source;
a collapsible shaft tube connected to the pop-up box and receivable within the pop-up box; a sprinkler head connected to the collapsible shaft tube, the sprinkler head having arms that are radially extendable and are collapsible within the pop-up box, wherein the arms are in fluid communication with the collapsible shaft tube through the sprinkler head;
a turbine and gear arrangement connected to the collapsible shaft tube and the sprinkler head, the turbine and gear arrangement in fluid communication with the collapsible shaft tube, whereby water flow from the shaft tube and through the turbine and gear arrangement causing rotation of the sprinkler head; and an aerator screen mixes air with water and creates raindrops to shower.
